(19) United States
(12) Patent Application Publication
(10) Pub. No.: US 2025/0224237 A1
(43) Pub. Date: Jul. 10, 2025

(54) METHOD FOR OFFLINE MAP MATCHING

(71) Applicant: Wherobots Inc., Scottsdale, AZ (US)

(72) Inventors: Jia Yu, Mercer Island, WA (US); Bo Peng, Beijing (CN)

(21) Appl. No.: 19/013,567

(22) Filed: Jan. 8, 2025

Related U.S. Application Data
(60) Provisional application No. 63/618,826, filed on Jan. 8, 2024.

(51) Int. Cl. G01C 21/30

(52) U.S. Cl. CPC G01C 21/30

(57) ABSTRACT

A method for a distributed offline map matching is described. The method includes receiving raw trajectory data representing a trajectory of a moving target and road network data with road segments across a path of the trajectory. The method further includes partitioning the raw trajectory data to trajectory segments of a maximum length l and the road network data into spatially indexed shards. Further, selecting road segments from the partitioned road network data located within a distance D from each trajectory segment so that the selected road segments are a subgroup of the partitioned road network data, and assembling the trajectory from the trajectory segments. Finally, performing a map matching operation using the assembled trajectory and the selected road segments to produce a path on the mapped area that best aligns with the path of the trajectory.

### CROSS-REFERENCE TO RELATED APPLICATIONS

This application claims priority to and benefit of U.S. Provisional Patent Application No. 63/618,826, filed on Jan. 8, 2024, the entire disclosure of which is hereby incorporated by reference.

### FIELD OF TECHNOLOGY

The present disclosure relates to offline map matching and more specifically to offline map matching algorithms for accurately determining which road or path in a digital map corresponds to the observed geographic coordinates.

### BACKGROUND

Map matching is a critical process in geographic information systems and location-based services. It involves aligning recorded geographic coordinates of trips (i.e., trajectories), typically obtained from global positioning system (GPS) or other location-tracking technologies, with a logical model of the real world represented by a digital map. This process is foundational in a wide range of applications, including satellite navigation, GPS tracking of freight, transportation engineering, and urban planning to name a few. The objective of map matching is to accurately determine which road or path in the digital map corresponds to the observed geographic coordinates, considering factors such as the accuracy of the location data, the density and layout of the road network, and the speed and direction of travel.

Map matching algorithms are broadly classified into real-time and offline algorithms. Realtime algorithms associate positions with the road network during recording by often trading accuracy for performance in live environments. Offline algorithms, which are used after the data is being recorded, prioritize accuracy, which allows for a more comprehensive analysis of the points collected.

Existing single-offline approaches primarily leverage Hidden Markov Models (HMM). The HMM approach uses emission probabilities to gauge the likelihood of a point belonging to a particular road segment and transition probabilities to estimate movement between segments. While these single machine approaches can produce map matching results with high accuracy, they fail at processing large volume of GPS trajectories (i.e., hundreds of millions of trajectories), such as those on a country-level road network.

Recent studies have explored ways to enhance map matching algorithms through cluster computation techniques. Despite these efforts, these methods often utilize inefficient distributed spatial data or graph partitioning strategies, and often neglect the unique aspects of the trajectories. This oversight results in suboptimal performance—i.e., unnecessary computations that substantially reduce the map matching speed.

Other approaches attempting to revamp an existing single-machine HMM-based method from scratch, encounter similar drawbacks. Such tightly integrated designs limit the integration of advancements in single-machine map matching algorithms. For instance, such approaches tend to tie query parallelism optimization to specific algorithms, making these methods inflexible and unable to adapt to emerging algorithms.

In contrast, the method disclosed herein introduces a novel distributed trajectory partitioning methodology that dynamically distributes the query workload across all machines within a cluster. Each machine may then independently execute any single-machine map matching algorithm. The disclosed method enables a fully decoupled architecture and provides a flexibility that ensures compatibility with a wide range of single-machine algorithms, fostering adaptability and innovation.

However, merely dividing trajectories into smaller segments to achieve better data partitioning balance while lacking a theoretical foundation that ensures map matching accuracy, can potentially lead to results less precise than those achieved with single-machine solutions. Additionally, designing efficient offline map matching algorithms can be challenging when considering data volume and quality, computational efficiency, the complexity of urban environments, and how to best handle noise and errors.

For instance, with respect to data volume and quality, offline algorithms are tasked with managing voluminous GPS datasets alongside expansive road networks. A notable example is the OpenStreetMap road network dataset of the United States, which occupies more than 100 GB of storage space when uncompressed. Similarly, the New York City Taxi and Limousine Commission amassed a staggering collection of over 1 billion taxi trajectories in New York City over a period of 14 years.

With respect to computational efficiency, processing large datasets requires efficient algorithms to minimize computation time and resource usage. Balancing accuracy with computational efficiency can be a major challenge.

With respect to complexity, urban areas often have dense road networks and frequent intersections which pose a significant challenge due to the complexity of accurately matching GPS points to the correct roads.

Finally, and with respect to handling noise and errors, GPS data can be noisy or contain errors due to a variety of factors that can affect the accuracy and precision of the received GPS signals. This is an inherent characteristic of GPS data. For example, minor drifts in satellite atomic clocks can introduce timing and positional errors. Efficiently filtering out these inaccuracies while preserving the integrity of the actual travel path is a crucial aspect of the map matching process.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### BRIEF SUMMARY

In various examples, the subject matter described herein relates to a map matching method that significantly enhances efficiency in processing large sets of data without compromising the map matching accuracy. According to some embodiments, this is achieved by leveraging distributed computing principles to handle vast amounts of data concurrently, vastly improving scalability and processing speed. Additionally, the disclosed method effectively addresses the accuracy-to-performance trade off observed in offline algorithms by enabling users to choose what is most important them—i.e., accuracy or performance. In some examples, the disclosed algorithm, which is a machine learning model that iteratively explores nearby routes to identify potential matches, enables users to define a maximum exploration radius for each GPS point that allows the search to terminate earlier.

According to some embodiments, the disclosed method incorporates probabilistic models used in Hidden Markov Models (HMM) approaches and offers a plug-and-play design such that it can run user-supplied HMM approaches in parallel without additional configuration. More specifically, the algorithm disclosed herein divides the large-scale offline map matching problem into smaller, region-specific map matching tasks. This decoupled design integrates seamlessly with new single-machine map matching algorithms, enabling the adoption of emerging techniques to enhance the speed and accuracy of the map matching process on individual machines.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 illustrates an extent of a trajectory and road segments intersecting the extent, in accordance with some embodiments.

FIG. 2 illustrates extents of trajectory segments and road segments intersecting the extents, in accordance with some embodiments.

FIG. 3 illustrates a method for performing map matching on each machine of a cluster computing system, in accordance with some embodiments.

FIG. 4 illustrates sub-operations of the map matching method illustrated in FIG. 3, in accordance with some embodiments.

FIG. 5 illustrates sub-operations of the map matching method illustrated in FIG. 3, in accordance with some embodiments.

FIG. 6 illustrates an exemplary system for implementing the map matching method illustrated in FIG. 3, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

To address the above shortcomings, the disclosed map matching method introduces a novel approach that significantly enhances efficiency in processing large sets of data without compromising the map matching accuracy. In some implementations, the disclosed method utilizes a cluster computing system for processing large-scale spatial data, such as Apache Sedona™, to co-partition trajectory and road network datasets based on the spatial proximity of their elements, ensuring balanced loads. Subsequent local map matching is performed within each partition using standard single-machine algorithms.

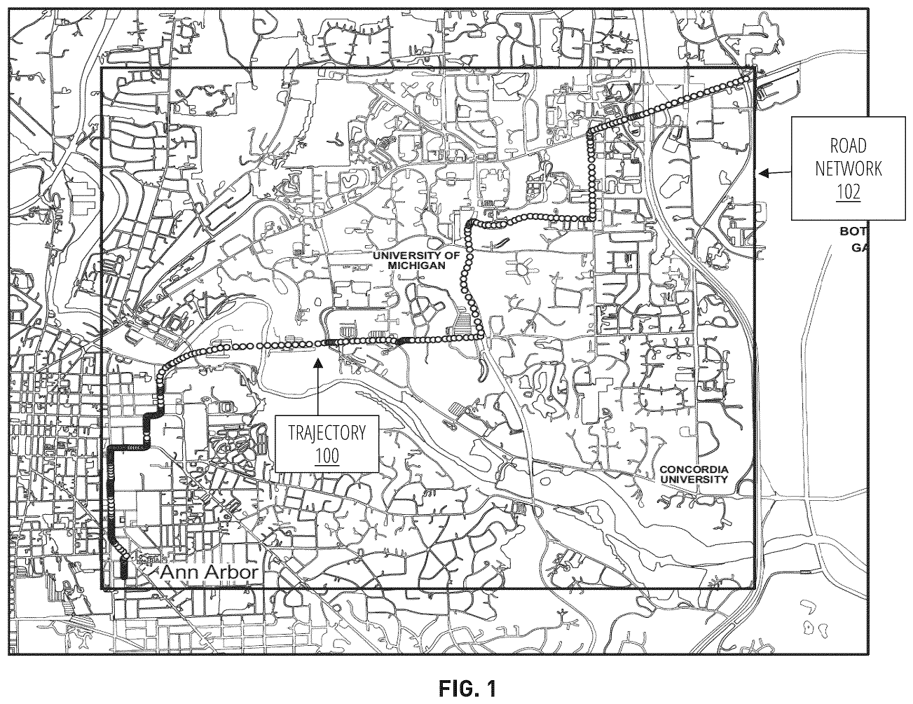

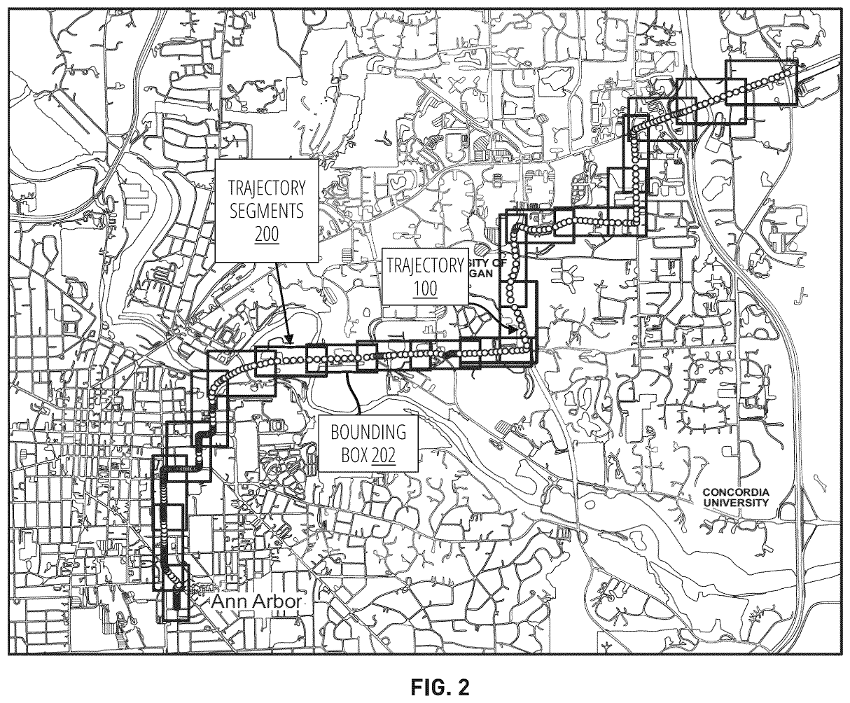

As depicted in FIG. 1, trajectory 100 often spans over large areas of a road network 102. Thus, simple data partitioning using the original trajectory 100 can result in a high replication rate, especially with substantial datasets. To address this, the disclosed method incorporates an additional step; namely, a trajectory splitting. This step is designed to reduce data redundancy and improve the efficiency of the partitioning process. Key concepts of the disclosed map matching method are discussed below in reference to FIGS. 1 and 2.

### Description of the Distributed Offline Map Matching Method

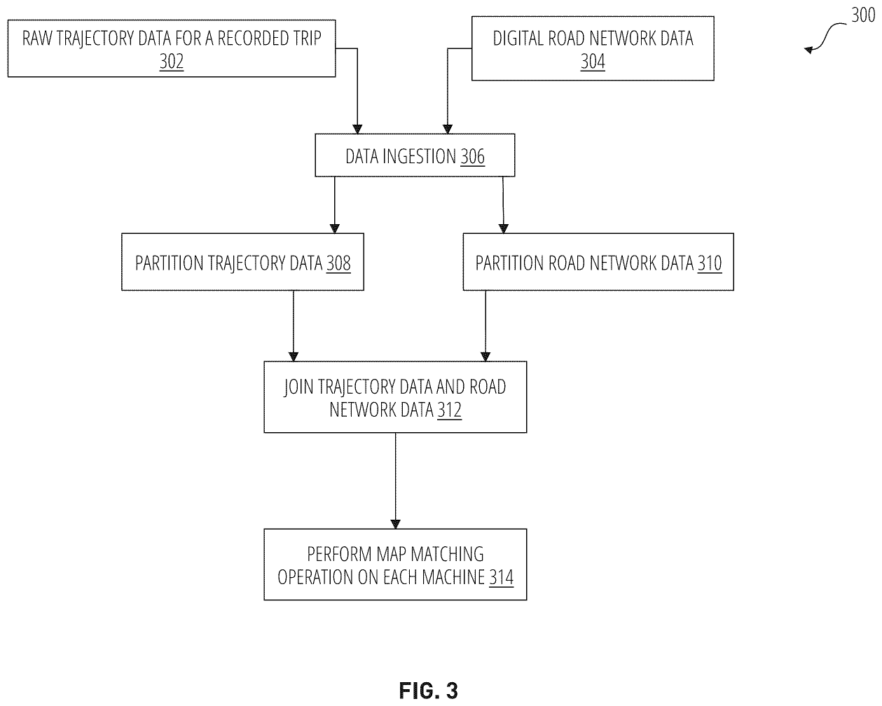

Reference is now made to FIG. 3 which illustrates a flowchart of map matching method 300 (thereafter method 300) according to some embodiments. Specifically, method 300 is a distributed offline map matching method implemented in one or more computer cluster systems, such as an Apache Sedona™ cluster computing system. According to some embodiments, method 300 may be implemented by an algorithm operable to run tasks described by method 300 on one or more computer cluster systems as would be discussed in more details below.

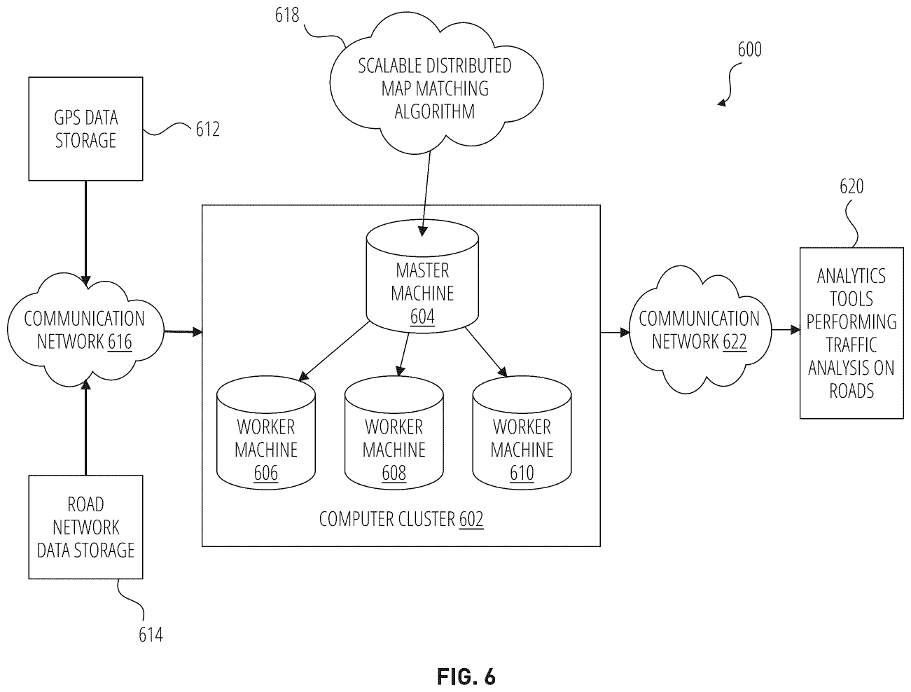

According to some embodiments, method 300 and its respective steps may be performed in a system, such as exemplary system 600 shown in FIG. 6. It is to be understood that FIG. 6 only shows selective non-limiting components of system 600. Accordingly, system 600 may include additional components not shown in FIG. 6 that can be essential for its operation, as would be understood by a skilled artisan. Some or all of the components discussed in connection to method 300 are shown in FIG. 6 and are discussed below.

As discussed above, method 300 is implemented in a computer cluster, such as the computer cluster 602 shown in FIG. 6. Computer cluster 602 may include a master machine 604 and worker machines 606, 608, and 610. Although only three worker machines are shown in FIG. 6, computer cluster 602 may include fewer or additional worker machines without limitation. In some implementations, computer cluster 602 is cluster computing system for processing large-scale spatial data, such as an Apache Sedona™ cluster computing system. Master machine 604, and worker machines 606, 608, and 610 are computer nodes performing selective operations of method 300.

In some implementations, the algorithm that is operable to execute method 300 has two main components. One component is operable to run on the master machine 604 of the computer cluster 602 and coordinate computing tasks with the worker machines 606, 608, and 610. A second component is operable to run on each of the worker machines 606, 608, and 610. By way of example and not limitation, the algorithm operable to execute method 300 is a scalable distributed map matching algorithm, such as the scalable distributed map matching algorithm 618 (thereafter algorithm 618) shown in FIG. 6.

Method 300 begins with data ingestion at step 306 during which data from suitable data sources is collected by master machine 604. According to some embodiments, the data may include raw trajectory data for a recorded trip 302 (thereafter referred to as raw trajectory data 302) and digital road network data 304. In some embodiments, the digital road network data 304 are related or relevant to the raw trajectory data 302. In other words, the digital road network data 304 include road network information of areas for which the raw trajectory data 302 are recorded. For example, if the raw trajectory data 302 contain trajectories for taxis in New York City, the digital road network data 304 may include road network information for all the boroughs in New York City.

In some implementations, the raw trajectory data 302, which include multiple GPS points for each recorded trip, can be generated by any suitable GPS unit or location-tracking system. Raw trajectory data 302 may be available from one or more databases that contain large datasets of raw trajectory data, such as a database containing voluminous raw trajectory data from commercial or private vehicles collected over a period of time. In some embodiments, raw trajectory data 302 may be requested or automatically pushed to master machine 604 via a network, such as communication network 616, connected to the internet. By way of example and not limitation, each trajectory in raw trajectory data 302 may be represented as an ordered list of tuples—for example, in the form of “(latitude, longitude, timestamp)”.

In referring to system 600 in FIG. 6, raw trajectory data 302 may originate from one or more GPS data storages 612. By way of example and not limitation, a GPS data storage 612 may be any suitable source of GPS data, such as a centralized database containing voluminous GPS data from one or more business entities. For instance, GPS data storage 612 may be a database operated by the New York City Taxi and Limousine Commission that stores taxi trajectories in New York City over any period of time (e.g., one or more years).

Similarly, road network data storage 614 may be any suitable source of road network data, such as a centralized database containing voluminous road network data from one or more business entities. For instance, road network data storage 614 may contain a road network dataset of the entire United States, which may occupy more than 100 GB of storage space when uncompressed. In other examples, digital road network data 304 may be collected from geospatial databases, such as the United States Open Street Map (OSM) or other suitable sources that have access to large road network data. By way of example and not limitation, digital road network data 304 may include any number of road segments (referred to as edges) and intersections (referred to as nodes) for one or more locations.

The prerequisites to run map matching is to obtain road segments near the trajectory. One straight forward approach is to run a distributed spatial join (i.e., combine information from different tables, such as those contained in raw trajectory data 302 and digital road network data 304, by using spatial relationships as the join key) to find nearby road segments of every single trajectory in a very large trajectory dataset. However, this approach can be very inefficient. The reason is that the extent of the trajectory could be very large so that the envelope of the trajectory intersects with a large fraction of road segments in the road network dataset. Consequently, the spatial join produces an extremely large result set, which makes it a substantially slow process. In this context, the term extent refers to the spatial or temporal range of data considered when determining the alignment of a sequence of global positioning system (GPS) points to a road network. For example, the circles making trajectory 100 shown in FIG. 1 may represent the extent of the GPS points collected for trajectory 100.

To mitigate the data replication issue and to improve the process efficiency in terms of time and computational burden, once raw trajectory data 302 and digital road network data 304 is collected at step 306, method 300 proceeds to steps 308 and 310 where algorithm 618 operated on master machine 604 partitions the trajectory and road network data. In some embodiments, steps 308 and 310 may be performed sequentially or concurrently without departing from the spirit and the scope of the disclosure. For example, in FIG. 3, steps 308 and 310 are shown to occur concurrently.

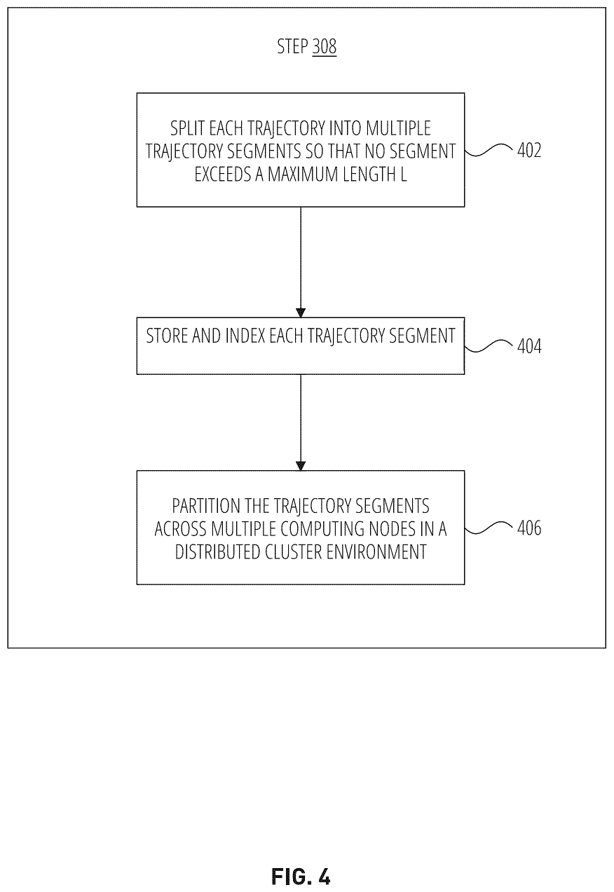

According to some embodiments, partitioning the trajectory data at step 308 can include additional sub-steps shown in FIG. 4. Specifically, step 308 may include sub-steps 402 through 406. In sub-step 402, each trajectory is split into multiple segments. Specifically, algorithm 618 is designed to split trajectory 100 into smaller pieces, referred to herein as trajectory segments, with a maximum length l. As illustrated in FIG. 2, with a proper/configured, the amount of nearby road segments selected by the trajectory segments 200 can be substantially shorter. In FIG. 2, each trajectory segment 200 is surrounded by a bounding box 202. This representation is not limiting, and each bounding box 202 may have any suitable polyline shape. Although a lower/value can reduce the data replication rate and the amount of nearby road segments that overlap with the trajectory segments 200, it may incur additional time cost when recovering the original trajectory.

In some embodiments, each trajectory segment 200 is treated as a smaller, more manageable piece of the original trajectory 100 and is configured so that it does not exceed a maximum length l. As discussed above, with length/properly configured by algorithm 618, the number of nearby road segments included within each trajectory segment 200 can be substantially reduced. This approach effectively reduces the data replication rate within computer cluster 602 on which method 300 is implemented. Data replication, a critical aspect of spatial data partitioning in distributed systems, ensures that each location (e.g., worker machine) has all the necessary information about neighboring objects. This enables parallel execution of computational tasks efficiently. It is noted however that because a very small/value can incur additional time cost when recovering the original trajectories (since the original trajectory is split into a larger number of segments), it is imperative that algorithm 618 selects the maximum length/value in sub-step 402 so that there is a balance between the desirable number of nearby road segments included within each trajectory segment 200 and the time cost incurred when recovering the original trajectories. In other words, algorithm 618 is configured to identify an/value that does not reduce the number of nearby road segments within each trajectory segment 200 at the expense of the time cost incurred when recovering the original trajectories. As such, algorithm 618 is configured to provide an optimized maximum length/value based on the number of nearby road segments within each trajectory segment 200 and the the time cost incurred when recovering the original trajectories.

In sub-step 404, algorithm 618 is operable to store and index each trajectory segment so that the trajectory segments 200 can be re-assembled to the original trajectory. In some embodiments, this process maintains reference information to the original trajectory so that the trajectory segments 200 can be recombined later with ease. According to some embodiments, sub-steps 402 and 404 are executed in master machine 604 by algorithm 618. Finally, in sub-step 406, algorithm 618 instructs master machine 604 to distribute the trajectory segments 200 among worker machine 606, 608, and 610. In other words, each worker machine 606, 608, and 610 receives a subset of the trajectory segments 200.

With respect to step 310, the digital road network data 304 is partitioned into spatially indexed shards. Each shard corresponding to a well-defined geographic region so that each worker machine in the computer cluster 602 handles only a subset of the entire road network. This approach greatly reduces the computational burden and the associated processing time at the worker machine level. According to some embodiments, the spatially index shards are distributed to the worker machines according to the distributed trajectory segments 200 that each worker machine received in sub-step 406. In other words, algorithm 618 is configured to divide the computational burden among worker machines 606, 608, and 610 by distributing the spatially indexed shards (i.e., the partitioned digital road network data 304) according to the trajectory segments 200 each worker machine received in sub-step 406 of step 308. This means that each worker machine only receives digital road network data 304 that is relevant to the trajectory segments 200 it received. This allows worker machines 606, 608, and 610 to operate only on a subset of the original raw trajectory data 302 and digital road network data 304, which improves the map matching efficiency even for voluminous amounts of data.

Next, method 300 proceeds to step 312 and performs a distributed spatial distance join between the trajectory segments and the partitioned road network. According to some embodiments, step 312 is coordinated by the first component of algorithm 618 on the master machine 604, and subsequently completed by the second component of algorithm 618 on each worker machine of computer cluster 602. In some implementations, the second component of algorithm 618 running on each worker machine of computer cluster 602 instructs each working machine to fetch nearby road segments (from the spatially indexed shards) for each of its distributed trajectory segments 200 within a certain distance D. Accordingly, each respective working machine identifies all road segments lying within distance D of each trajectory segment's bounding box or polyline that the working machine is responsible for. In other words, the identified road segments are a reduced road network surrounding each trajectory segment within distance D. In some implementations, distance D is a hyperparameter that can be tuned by the component of the algorithm 618 running on the master machine 604 of computer cluster 602. Examples of how distance D can be tuned are provided below.

In some embodiments, if the (local) map matching operation applied in the next step of method 300 (i.e., step 314) requires setting a maximum probe distance to match the GPS coordinates to roads, the same maximum probe distance may be applied in step 312 as the distance D, so that algorithm 618 does no compromise the matching accuracy. Although a smaller value of distance D (e.g., smaller than the maximum probe distance used during the execution of the local map matching operation described in step 314) would speed up the distributed map matching process, it would adversely impact the accuracy of the map matching process.

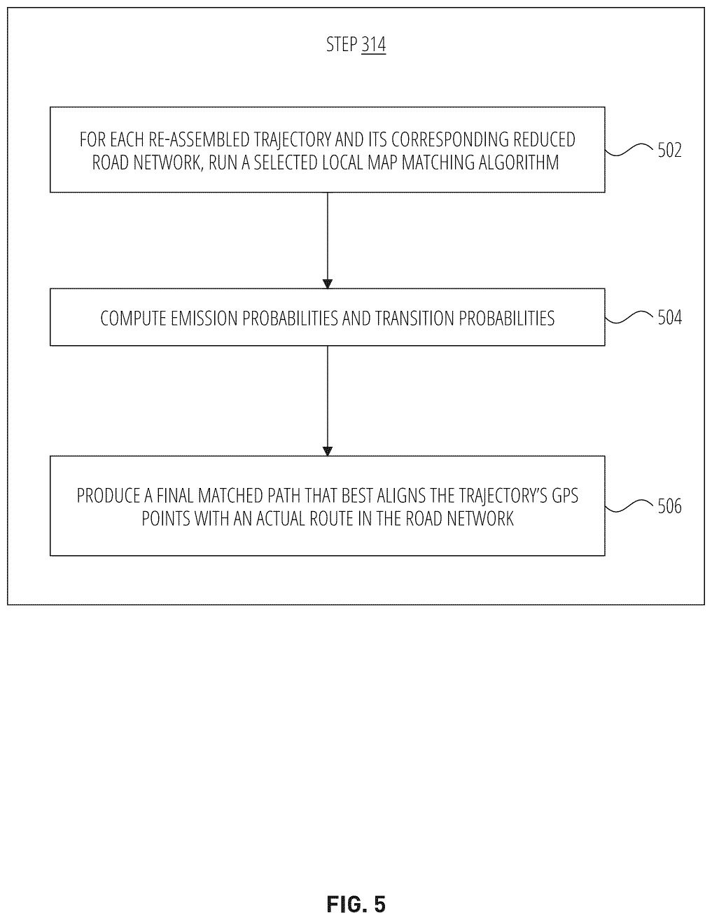

From step 312, method 300 proceeds to step 314 where each worker machine in the computer cluster 602 performs a map matching operation (also referred to herein as local map matching operation) using the distributed spatial joined data from previous step 312. In some embodiments, the local map matching operation in step 314 may include additional sub-steps as shown in FIG. 5. In some embodiments, these sub-steps are executed on each working machine by the map matching algorithm component of algorithm 618 running on each working machine. Alternatively, the local map operation portion of method 300 may be executed by a user selected map matching algorithm different from the map matching algorithm of algorithm 618. In other words, method 300 offers the flexibility to users to use for this particular step of the process (i.e., the local map matching operation; step 314) their own map matching algorithm that can be different from the match-mapping algorithm used by algorithm 618. In some embodiments, the user selected map matching algorithm for the local matching operation of step 314 can be any single-host map matching algorithm without limitation.

In sub-step 502, trajectory segments 200 and their nearby road segments are assembled together to get the original trajectory 100 and all road segments nearby the trajectory. In some examples, this re-assemble operation may be implemented as a reduceByKey transformation. Subsequently, each working machine executes a selected local map matching algorithm for the the re-assembled trajectory (e.g., trajectory 100) and the reduced road network (i.e., the road segments) for which the working machine is responsible. Thus, all the working machines, collectively, perform a map matching operation between the entire trajectory and its nearby road segments. As discussed above, the selected local map matching algorithm can be a map matching algorithm of algorithm 618 or different—i.e., a user selected map matching algorithm. By way of example and not limitation, the selected local map matching algorithm can be, for example, a Hidden Markov Model-based approach. Subsequently, at sub-step 504, each worker machine computes emission probabilities to determine how likely each GPS point is to lie on a given road segment, and transition probabilities to select the most probable path through the reduced network. Finally, at sub-step 506, each worker machine produces a final matched path that best aligns the trajectory's GPS points with an actual route in the road network.

Once method 300 ends, the matched trajectory data can be transferred from computer cluster 602 to one or more analytics tools 620 performing traffic analysis on roads. In some embodiments, computer cluster 602 and analytics tools 620 are communicatively coupled by any suitable secure network, such as communication network 622 which can be the same or different from communication network 616.

### Benchmark Results and Comparisons

By way of example and not limitation, the algorithm can be implemented using an Apache Sedona™ computer cluster. A Java version of Leuven MapMatching may be employed for benchmarking purposes as the local map matching algorithm of method 300. To ensure accuracy parity with the map matching algorithm, the value of D in step 312 can be set to the maximum probe distance used in the local map matching algorithm used in step 314. This alignment ensures that method 300 and algorithm 618 retains the same level of accuracy as the original Leuven MapMatching.

### Small Scale, Real-World Datasets

For benchmarking purposes, a vehicle energy dataset (VED) may be selected that includes a large number of trajectories—e.g., in the tens of thousands range, such as 30,000, 35,000, 40,000, etc. The distributed map matching operation of method 300 may run on an open street map (OSM) road network of the desired area. The experiments may also run on a computer clusters with various number of worker machines, such as a Wherobots SedonaDB cluster. In some examples, each worker machine can have an Intel Xeon® Platinum 825CL core processing unit (CPU) with 32 cores and 128 gigabytes (GB) of random access memory (RAM).

### Tuning Hyperparameter D and Maximum Length of l

In some implementations, various configurations of hyperparameter D may be evaluated by algorithm 618 to optimize both performance and accuracy (matching quality). The matching quality or accuracy may be evaluated via the implementation of two accuracy metrics, Accuracy by Number (A_{N}) and Accuracy by Length (A_{L}), defined as follows:

$${A}_{N} = \frac{\# correctly matched road segments}{\# all road segments of the trajectory}$$

$${A}_{L} = \frac{Σ [ The length of matched road segments ]}{The length of the trajectory}$$

The results of method 300 can be compared to those produced by conventional map matching methods, such as the GraphHopper map matching. The improvement can be evaluated by comparing the accuracy metrics A_{N} and A_{L} produced by each method. It is noted that the Leuven MapMatching used in method 300 may produce different, yet still accurate, match results to conventional matching methods, such as the GraphHopper, since both approaches use probabilistic HMM models.

Table 1 below shows the effect of hyperparameter D on the execution time and accuracy metrics A_{L} and A_{N} when the value of hyperparameter D varies between 50 m and 200 m at a step of 25 m. Execution time in seconds(s) is shown for 2, 4, and 8 executors (e.g., a worker machine).

TABLE 1
Effect of hyperparameter D on execution time and accuracy metrics

| D (m) | 2 Executors (s) | 4 Executors (s) | 8 Executors (s) | A_{N} | A_{L} |
|---|---|---|---|---|---|
| 50 | 31.16 | 25.25 | 19.72 | 0.52 | 0.65 |
| 75 | 41.77 | 31.66 | 21.42 | 0.59 | 0.74 |
| 100 | 66.90 | 42.93 | 28.39 | 0.61 | 0.76 |
| 125 | 171.76 | 95.42 | 57.66 | 0.61 | 0.76 |
| 150 | 283.59 | 143.27 | 80.48 | 0.61 | 0.76 |
| 175 | 366.44 | 196.42 | 107.02 | 0.61 | 0.76 |
| 200 | 458.57 | 236.85 | 130.49 | 0.61 | 0.76 |

According to Table 1, a higher D value incurs longer execution times across all executor examples but results in a higher map matching accuracy as indicated by the values of accuracy metrics A_{N} and A_{L}. Additionally, the accuracy metrics A_{N} and A_{L} appear to plateau around a fixed value when hyperparameter D is equal to or greater than 100 m (e.g., D≥100 m).

Table 2 below shows the effect of maximum length I on execution time for a constant D value of 100 m when the length/varies between 0.1 km and 2.0 km. The execution time in seconds(s) is shown for 2, 4, and 8 executors.

TABLE 2
Effect of maximum length of l on execution
time for a constant D value

| l (km) | 2 Executors (s) | 4 Executors (s) | 8 Executors (s) |
|---|---|---|---|
| 0.1 | 70.33 | 42.88 | 31.14 |
| 0.3 | 66.57 | 41.43 | 31.35 |
| 0.5 | 66.03 | 41.40 | 29.55 |
| 0.7 | 67.26 | 43.24 | 29.66 |
| 1.0 | 68.81 | 41.95 | 30.25 |
| 1.5 | 70.69 | 43.15 | 30.87 |
| 2.0 | 72.20 | 48.03 | 30.20 |

As shown by Table 2, an l value of 0.5 km produces the shortest execution time across all executor examples.

### Large Scale, Synthetic Dataset

A large scale, synthetic dataset can be produced by running a map matching with method 300 using the United States open street map (OSM) road network, which features 662,123,468 edges to generate 16,071,759 trajectories scattered across the United States. By way of example and not limitation, such benchmark can run on a Spark computer cluster with 32 executor instances. The results are shown in Table 3 below.

TABLE 3
Results for large scale, synthetic dataset

| Executor | | | | Map Matching |
|---|---|---|---|---|
| Instances | D (m) | l (km) | Time Spent (s) | Time (min) |
| 32 | 100 | 0.1 | 1274.76 (21 min) | 17 |

This test demonstrates that the method 300 and algorithm 618 works efficiently with large datasets (600M edges) and produce results within a short time period of 21 mins.

Comparison with Traditional, Single-Machine Algorithms

Table 4 below summarizes the results for a local machine map matching that uses a small-scale real-world dataset. In this example, the entire road network is loaded into the memory and the trajectories are matched in parallel using multiple threads. In this specific example, the experiment runs on an AWS EC2 instance with Intel Xeon® Platinum 8259CL CPU with 32 cores and 128 GB of RAM. For this experiment, the I and D values selected are 0.5 km and 100 m, respectively.

TABLE 4
Map matching on a local machine

| Threads | Time Spec (s) | Comment |
|---|---|---|
| 8 | 179.75 | |
| 16 | 99.41 | |
| 32 | 96.28 | Observed low instructions per cycle |
| | | (IPC) bounded by memory access. |

As shown by the benchmark results in Tables 1-2 and 4, the distributed map matching strategy run by method 300, while incurring some overhead compared to a single-host serial algorithm, demonstrates superior performance compared to the single-machine approach for large datasets through resource scaling. Most importantly, the disclosed distributed map matching strategy is capable of processing datasets that are too large for a single machine, demonstrating robust scalability in very large-scale offline map matching scenarios.

### Summary of Benefits for the Disclosed Method and Distributed Map Matching Algorithm

Method 300 executed by algorithm 618 on computer cluster 602 provide several benefits over conventional single-host algorithms in terms of (i) scalability and performance, (ii) efficiency, (iii) accuracy versus performance trade-off, (iv) robustness in challenging road network environments, and (v) integration with existing solutions.

With respect to scalability and performance, the disclosed distributed offline map matching approach can handle substantially larger datasets than conventional single-machine methods. By splitting trajectories and co-partitioning data spatially, the process can be parallelized across dozens or even hundreds of computing nodes. This parallelization greatly reduces computation time compared to single-host algorithms.

With respect to efficiency, segmenting trajectories and performing targeted spatial joins, the disclosed algorithm limits the amount of extraneous data that needs to be processed. Fewer unnecessary road segments are fetched, resulting in reduced data replication and memory overhead. This makes the process more resource-efficient and can reduce operational costs.

With respect to accuracy versus performance trade-off, the disclosed method allows fine-tuning of hyperparameters (e.g., D and l) to optimize performance and accuracy. Users are allowed to choose between speed, memory usage, or accuracy depending on project requirements. The disclosed method guarantees that accuracy is maintained even as data volume increases.

With respect to robustness in challenging road network environments, such as complex urban environment that may include a large number of road segments (edges) and intersections (nodes), the disclosed method effectively focuses on segmenting the trajectory and nearby roads, which can effectively manage dense and complex urban road networks. Even with noisy GPS data, the disclosed method maintains reliable performance and can achieve accuracy comparable to best-in-class single-host map matching solutions.

Finally, with respect to the integration with existing solutions, the disclosed method promotes the use of user-supplied local map matching algorithms without additional extensive integration work. This means that advances in local map matching techniques can be seamlessly incorporated, protecting and enhancing prior investments in established map matching algorithms.

### SOME EMBODIMENTS

Some embodiments may include any of the following:

A.1. A method for a distributed offline map matching, the method includes receiving raw trajectory data as a collection of data points from a location tracking system, the raw trajectory data representing a trajectory of a moving target on a mapped area; receiving road network data of the mapped area, the road network data having road segments across a path of the trajectory. The method further includes partitioning the raw trajectory data to trajectory segments of a maximum length l; partitioning the road network data into spatially indexed shards, each spatially indexed shard corresponding to a defined geographical region around a respective one of the trajectory segments; and performing a distributed spatial distance join between the trajectory segments and the partitioned road network data, where performing the distributed spatial distance join includes selecting road segments from the partitioned road network data located within a distance D from each trajectory segment so that the selected road segments are a subgroup of the partitioned road network data. Lastly, the method includes assembling the trajectory from the trajectory segments, and performing a map matching operation using the assembled trajectory and the selected road segments to produce a path on the mapped area that best aligns with the path of the trajectory.

A.2. A non-transitory computer-readable storage medium, the computer-readable storage medium including instructions that when executed by a computer, cause the computer to receive raw trajectory data containing a collection of data points from a location tracking system, the raw trajectory data representing a trajectory of a moving target; receive road network data containing road segments along the trajectory. The instructions when executed by the computer further cause the computer to partition the raw trajectory data into trajectory segments of a maximum length having a value l, where the value l is based on (i) a number of road segments near each trajectory segment, and (ii) a time cost incurred when assembling the trajectory from all the trajectory segments; partition the road network data into spatially indexed shards, each spatially indexed shard representing a geographical region around a respective one of the trajectory segments; selecting road segments from the partitioned road network data so that the selected road segments are located within a distance D from each nearby trajectory segment, where the selected road segments are a subgroup of the partitioned road network data within each spatially indexed shard. Finally, the instructions when executed by the computer further cause the computer to assemble the trajectory from the trajectory segments, and perform a map matching operation using the assembled trajectory and the selected road segments to produce a path that best aligns with the trajectory of the moving target.

A.3. A method for running a distributed offline map matching on a computer cluster with a master machine and two or more worker machines, the method includes instructing the master machine to obtain raw trajectory data from one or more external sources over a network, the raw trajectory data being a collection of coordinates and timestamps from a location tracking system, and the raw trajectory data representing a trajectory of a moving target on a mapped area. The method further includes instructing the master machine to obtain road network data for the mapped area from one or more external sources over the network, the road network data having road segments in the vicinity of the trajectory. The method also includes instructing the master machine to partition the raw trajectory data into trajectory segments of a maximum length l; instructing the master machine to partition the road network data into spatially indexed shards, each spatially indexed shard corresponding to a defined geographical region around a respective one of the trajectory segments; instructing the master machine to distribute the trajectory segments and the partitioned road network data across the two or more worker machines; instructing the master machine to perform a distributed spatial distance join between the trajectory segments and the partitioned road network data, where performing the distributed spatial distance join includes instructing the two or more worker machines to select road segments from the partitioned road network data located within a distance D from each trajectory segment so that the selected road segments form a subgroup of the partitioned road network data. Finally the method includes instructing the master machine to assemble the trajectory from the trajectory segments, and instructing the two or more worker machines to perform a map matching operation using the assembled trajectory and the selected road segments to produce a path on the mapped area that best aligns with a path of the trajectory.

### ADDITIONAL CONSIDERATIONS

The phrasing and terminology used herein is for the purpose of description and should not be regarded as limiting.

Although the concepts and principles of operation for system 600 have been described with limited number of components for simplicity, system 600 may include additional electrical and/or mechanical components necessary for its operation. These additional components are within the spirit and the scope of this disclosure.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “in some embodiment,” “according to some embodiments,” or “in some implementations” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

In some embodiments, aspects of the systems and methods described herein may be implemented using ML and/or AI technologies.

“Machine learning” generally refers to the application of certain techniques (e.g., pattern recognition and/or statistical inference techniques) by computer systems to perform specific tasks. Machine learning techniques may be used to build models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference data set.

As used herein, “model” may refer to any suitable model artifact generated by the process of using a machine learning algorithm to fit a model to a specific training data set. The terms “model,” “data analytics model,” “machine learning model” and “machine learned model” are used interchangeably herein.

As used herein, the “development” of a machine learning model may refer to construction of the machine learning model. Machine learning models may be constructed by computers using training data sets. Thus, “development” of a machine learning model may include the training of the machine learning model using a training data set. In some cases (generally referred to as “supervised learning”), a training data set used to train a machine learning model can include known outcomes (e.g., labels or target values) for individual data samples in the training data set. For example, when training a supervised computer vision model to detect images of cats, a target value for a data sample in the training data set may indicate whether or not the data sample includes an image of a cat. In other cases (generally referred to as “unsupervised learning”), a training data set does not include known outcomes for individual data samples in the training data set.

Following development, a machine learning model may be used to generate inferences with respect to “inference” data sets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

“Artificial intelligence” (AI) generally encompasses any technology that demonstrates intelligence. Applications (e.g., machine-executed software) that demonstrate intelligence may be referred to herein as “artificial intelligence applications,” “AI applications,” or “intelligent agents.” An intelligent agent may demonstrate intelligence, for example, by perceiving its environment, learning, and/or solving problems (e.g., taking actions or making decisions that increase the likelihood of achieving a defined goal). In many cases, intelligent agents are developed by organizations and deployed on network-connected computer systems so users within the organization can access them. Intelligent agents are used to guide decision-making and/or to control systems in a wide variety of fields and industries, e.g., security; transportation; risk assessment and management; supply chain logistics; and energy management. Intelligent agents may include or use models.

Some non-limiting examples of AI application types may include inference applications, comparison applications, and optimizer applications. Inference applications may include any intelligent agents that generate inferences (e.g., predictions, forecasts, etc.) about the values of one or more output variables based on the values of one or more input variables. In some examples, an inference application may provide a recommendation based on a generated inference. For example, an inference application for a lending organization may infer the likelihood that a loan applicant will default on repayment of a loan for a requested amount, and may recommend whether to approve a loan for the requested amount based on that inference. Comparison applications may include any intelligent agents that compare two or more possible scenarios. Each scenario may correspond to a set of potential values of one or more input variables over a period of time. For each scenario, an intelligent agent may generate one or more inferences (e.g., with respect to the values of one or more output variables) and/or recommendations. For example, a comparison application for a lending organization may display the organization's predicted revenue over a period of time if the organization approves loan applications if and only if the predicted risk of default is less than 20% (scenario #1), less than 10% (scenario #2), or less than 5% (scenario #3). Optimizer applications may include any intelligent agents that infer the optimum values of one or more variables of interest based on the values of one or more input variables. For example, an optimizer application for a lending organization may indicate the maximum loan amount that the organization would approve for a particular customer.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this invention, it is to be appreciated that various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method for a distributed offline map matching, the method comprising:
receiving raw trajectory data comprising a collection of data points from a location tracking system, the raw trajectory data representing a trajectory of a moving target on a mapped area;
receiving road network data of the mapped area, the road network data comprising road segments across a path of the trajectory;
partitioning the raw trajectory data to trajectory segments of a maximum length l;
partitioning the road network data into spatially indexed shards, each spatially indexed shard corresponding to a defined geographical region around a respective one of the trajectory segments;
performing a distributed spatial distance join between the trajectory segments and the partitioned road network data, wherein performing the distributed spatial distance join comprises selecting road segments from the partitioned road network data located within a distance D from each trajectory segment so that the selected road segments are a subgroup of the partitioned road network data;
assembling the trajectory from the trajectory segments; and
performing a map matching operation using the assembled trajectory and the selected road segments to produce a path on the mapped area that best aligns with the path of the trajectory.

2. The method of claim 1, wherein performing the map matching operation comprises setting a maximum probe distance for matching the trajectory data to the selected road segments.

3. The method of claim 2, wherein the distance D is a hyperparameter selected to match the maximum probe distance.

4. The method of claim 1, wherein performing the map matching operation comprises a Hidden Markov Model-based approach.

5. The method of claim 1, wherein performing the map matching operation comprises:
computing emission probabilities to determine how likely each of the raw trajectory data lies on a given road segment; and
computing transition probabilities to select a most probable path through the selected road segments.

6. The method of claim 1, wherein the raw trajectory data represent coordinates from a global positioning system (GPS).

7. The method of claim 1, wherein partitioning the raw trajectory data comprises selecting the maximum length/so that a number of road segments near the trajectory segments is balanced with a time cost incurred when assembling the trajectory segments back to the trajectory.

8. A non-transitory computer-readable storage medium, the computer-readable storage medium including instructions that when executed by a computer, cause the computer to:
receive raw trajectory data comprising a collection of data points from a location tracking system, the raw trajectory data representing a trajectory of a moving target;
receive road network data comprising road segments along the trajectory;
partition the raw trajectory data into trajectory segments of a maximum length having a value l, wherein the value l is based on (i) a number of road segments near each trajectory segment, and (ii) a time cost incurred when assembling the trajectory from all the trajectory segments;
partition the road network data into spatially indexed shards, each spatially indexed shard comprising a geographical region around a respective one of the trajectory segments;
selecting road segments from the partitioned road network data so that the selected road segments are located within a distance D from each nearby trajectory segment, wherein the selected road segments are a subgroup of the partitioned road network data within each spatially indexed shard;
assemble the trajectory from the trajectory segments; and
perform a map matching operation using the assembled trajectory and the selected road segments to produce a path that best aligns with the trajectory of the moving target.

9. The non-transitory computer-readable storage medium of claim 8, wherein the distance D is a hyperparameter selected to match a maximum probe distance used when matching the raw trajectory data to the selected road segments during the map matching operation.

10. The non-transitory computer-readable storage medium of claim 9, wherein to perform the map matching operation comprises a Hidden Markov Model-based approach.

11. The non-transitory computer-readable storage medium of claim 9, wherein to perform the map matching operation comprises:
computing emission probabilities to determine how likely each of the trajectory data lies on a given road segment; and
computing transition probabilities to select a most probable path through the selected road segments.

12. The non-transitory computer-readable storage medium of claim 9, wherein the raw trajectory data are represented as an ordered list of tuples.

13. The non-transitory computer-readable storage medium of claim 9, wherein the raw trajectory data contain latitude, longitude, and timestamp information.

14. A method for running a distributed offline map matching on a computer cluster comprising a master machine and two or more worker machines, the method comprises:
instructing the master machine to obtain raw trajectory data from one or more external sources over a network, the raw trajectory data comprising a collection of coordinates and timestamps from a location tracking system, the raw trajectory data representing a trajectory of a moving target on a mapped area;
instructing the master machine to obtain road network data for the mapped area from one or more external sources over the network, the road network data comprising road segments in the vicinity of the trajectory;
instructing the master machine to partition the raw trajectory data into trajectory segments of a maximum length l;
instructing the master machine to partition the road network data into spatially indexed shards, each spatially indexed shard corresponding to a defined geographical region around a respective one of the trajectory segments;
instructing the master machine to distribute the trajectory segments and the partitioned road network data across the two or more worker machines;
instructing the master machine to perform a distributed spatial distance join between the trajectory segments and the partitioned road network data, wherein performing the distributed spatial distance join comprises instructing the two or more worker machines to select road segments from the partitioned road network data located within a distance D from each trajectory segment so that the selected road segments form a subgroup of the partitioned road network data;
instructing the master machine to assemble the trajectory from the trajectory segments; and
instructing the two or more worker machines to perform a map matching operation using the assembled trajectory and the selected road segments to produce a path on the mapped area that best aligns with a path of the trajectory.

15. The method of claim 14, wherein the distance D is a hyperparameter defined in the master machine and communicated to the two or more worker machines prior to instructing the two or more worker machines to select road segments from the partitioned road network data.

16. The method of claim 15, wherein the distance D is set to be equal to match a maximum probe distance used when matching the raw trajectory data to the selected road segments by the two or more worker machines during the map matching operation.

17. The method of claim 14, wherein instructing the two or more worker machines to perform a map matching operation comprises using a single-host map matching algorithm.

18. The method of claim 14, wherein instructing the two or more working machines to perform a map matching operation comprises using a map matching algorithm selected by a user.

19. The method of claim 14, wherein instructing the two or more worker machines to perform a map matching operation comprises using a third-party map matching algorithm.

20. The method of claim 14, wherein instructing the master machine to distribute the trajectory segments and the partitioned road network data across the two or more worker machines and instructing the two or more worker machines to perform the map matching operation reduces a total time for executing an offline map matching process compared to a single-machine offline map matching operation.
